(19) United States
(12) Patent Application Publication
(10) Pub. No.: US 2024/0084867 A1
(43) Pub. Date: Mar. 14, 2024

(54) BUFFERING DEVICE FOR EXPOSED ENDS OF SCAFFOLDING TUBES

(71) Applicant: Greg Sharp, LA PORTE, TX (US)

(72) Inventor: Greg Sharp, LA PORTE, TX (US)

(21) Appl. No.: 17/941,022

(22) Filed: Sep. 9, 2022

(51) Int. Cl. F16F 7/00; E04G 5/00; E04G 21/24

(52) U.S. Cl. CPC F16F 7/00; E04G 5/00; E04G 21/24; F16F 2224/025; F16F 2230/0023

(57) ABSTRACT

A buffering device for capping exposed ends of poles. The buffering device provides enhanced buffering against external impacts and a large surface area. The buffering device includes a head and a sleeve, wherein the head is of mushroom shape. The sleeve can receive an end portion of a pole.

### CROSS-REFERENCE TO RELATED APPLICATIONS

This application claims priority from a U.S. Provisional Patent Appl. No. 63/219,575 filed on Jul. 8, 2021, which is incorporated herein by reference in its entirety.

### FIELD OF INVENTION

The present invention relates to a buffering cap, and more particularly, the present invention relates to a buffering cap for exposed ends of vertical posts.

### BACKGROUND

Standing poles, T-posts, rods, scaffolding tubes, and the like are well-known building structures. Poles and the like are widely used as a framework in construction. Such poles and the like are installed upstanding with their top ends exposed. The exposed top ends of upstanding poles are a potential hazard. People can get hurt by the edges of the exposed ends. Moreover, the ends can tear any coverings, such as plastic sheets.

A need is therefore appreciated for a device that can cover the exposed ends of such poles and like objects.

The term “pole” herein refers to an elongated and narrow object, such as poles, T-post, rods, Scaffolding Tubes, pipes, and the like.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a buffering device for the exposed ends of the poles.

It is another object of the present invention that the buffering device has a buffering effect against an impact.

It is still another object of the present invention that the buffering device can protect against the edges of the pole.

It is a further object of the present invention that the bigger size and smooth surface of the buffering device can support coverings, such as plastic film, canvas tarps, etc.

It is yet another object of the present invention that the buffering device is visible from long distances.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of the buffering device, according to an exemplary embodiment of the present invention.

FIG. 2 is a front view of the buffering device, according to an exemplary embodiment of the present invention.

FIG. 3 is a bottom view of the buffering device, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

Disclosed is a buffering device for exposed ends of a pole. The pole can be a pole, a tube, a pipe, a T-post, and the like elongated tubular objects. The disclosed device can cover the exposed ends of the poles and further provides a buffering effect against external impacts. The buffering effect can protect persons from accidentally colliding with exposed ends of the poles. The cushion effect, large size, and rounded shape of the disclosed buffering device can significantly reduce an impact and protect a person that may accidentally collide with the ends of the poles. For example, a person may fall on upstanding poles at a construction site, wherein the cushioning and large size of the disclosed buffering device can reduce the impact significantly preventing any fatal injuries. Also, it is quite common to use poles for temporary roof covers, such as canvas tarps. However, the exposed ends of the pole can tear such coverings. The disclosed buffering device can cover such exposed ends to prevent damage to the covering. Moreover, the large surface area of the buffering device can help retain the covering. The disclosed buffering device can be made from materials, such as rubber and silicon that has the desired durability, softness, and grip. The grip can help retain the coverings while the softness can provide the desired buffer.

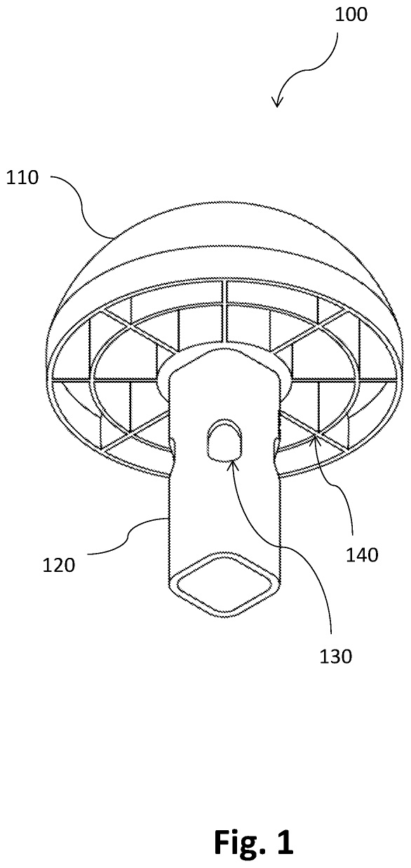

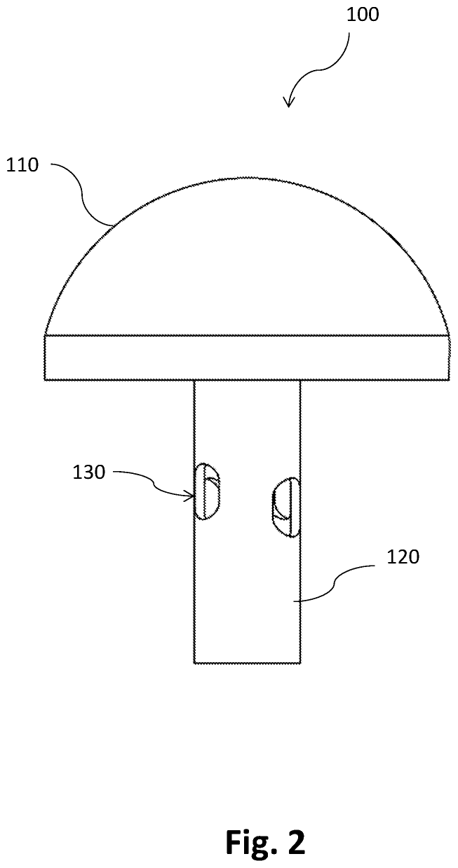

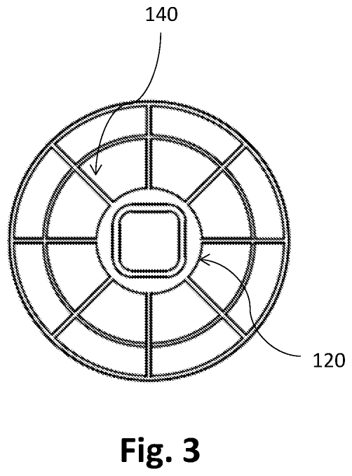

Referring to FIGS. 1-3 which show an exemplary embodiment of the disclosed buffering device, FIG. 1 is a perspective view thereof, FIG. 2 is a front view thereof, and FIG. 3 is a bottom view thereof. The buffering device 100 can be of a mushroom shape having a big head 110 and a sleeve 120 that extends from a bottom of the head 110. The head 110 can be large in size for enhanced buffering effect and large surface area. Moreover, the large size head can be easily visible from a long distance. The large size head can provide an umbrella like capping for the exposed ends of the pole.

The head can be made from soft and durable materials, such as rubber and silicon. The material should be durable to itself withstand the exposed ends of the poles as well as provide desired buffering against external impacts. The rubber and silicon can also provide a rubbery surface for grip against slipping of the coverings, such as plastic sheets and canvas tarps. The color for the head can be chosen such that the head is visible from a long distance. For example, the head can have red, orange, and like colors.

The sleeve 120 can extend from the bottom of the head and can be integral with the head such as the head and sleeve can be a single unit. The sleeve can receive end portions of the poles. The length of the sleeve can be varied, such as the buffering device can be stably mounted and retained on the pole. The size of the opening of the sleeve can be proportional to a width or diameter of the pole. In one implementation, the sleeve can be snugly fit over the end portion of the pole. Alternatively, the sleeve can loosely fit over the end portion of the pole. Or the sleeve can just slide over the end portion of the pole. The sleeve can have one or more holes 130 through which fasteners can be inserted to secure the buffering device to the end portion of the pole. The sleeve can be made from the same material that makes the head. Alternatively, the sleeve can be made from a different material. In one implementation, the elongated sleeve can be optional, wherein a groove can be provided within the head for receiving the end portion of the sleeve.

In one implementation, the head may not be completely solid but can be hollow from the inside, as shown in FIGS. 1 and 3. A honeycomb structure 140 integral with the head and the sleeve can provide desired strength and durability to the head and the sleeve. The head, the honeycomb structure, and the sleeve can be integrally formed as a single unit. The area of the head within the sleeve that may come in contact with the end of the pole can be thickened for durability against the edges of the poles.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A buffering device for an exposed end of a pole, the buffering device comprises:
a head; and
a sleeve that extends from a bottom of the head, wherein the head and the sleeve form a mushroom shape, the sleeve is sized to receive an end portion of the pole.

2. The buffering device according to claim 1, wherein the sleeve has one or more holes for one or more fasteners to pass through for securing the buffering device to the end portion of the pole.

3. The buffering device according to claim 1, wherein the buffering device is made of rubber.

4. The buffering device according to claim 1, wherein the buffering device is made of silicone.

5. The buffering device according to claim 1, wherein the buffering device further comprises a honeycomb structure within an internal cavity of the head.

6. The buffering device according to claim 5, wherein the head, the honeycomb structure, and the sleeve are integrally formed as a single unit.

7. The buffering device according to claim 6, wherein a portion of the head within the sleeve is thickened more than a rest of the head.

8. The buffering device according to claim 1, wherein a largest diameter of the head is at least twice a diameter of the pole.

9. The buffering device according to claim 1, wherein the sleeve snugly fits over the end portion of the pole.

10. The buffering device according to claim 1, wherein the sleeve freely slides over the end portion of the pole.
